(19) United States
(12) Patent Application Publication
(10) Pub. No.: US 2021/0308715 A1
(43) Pub. Date: Oct. 7, 2021

(54) PAINT ROLLER SYSTEM

(71) Applicant: Uvaldo Vera Martin, Salem, OR (US)

(72) Inventor: Uvaldo Vera Martin, Salem, OR (US)

(21) Appl. No.: 17/301,287

(22) Filed: Mar. 30, 2021

Related U.S. Application Data
(60) Provisional application No. 63/005,295, filed on Apr. 4, 2020.

(51) Int. Cl. B05C 17/03

(52) U.S. Cl. CPC B05C 17/0308; B05C 17/0333

(57) ABSTRACT

Improved, higher-capacity, portable, enhanced continuously-fed, paint roller system, comprising a portable paint container, shoulder straps attached to the portable container, a paint roller and perforated roller frame adapted for allowing paint to absorb into the outer roller material for rolling application to a surface, a handle member interconnected with the roller conduit frame; a hose connected between the roller frame and the container, means for pressurization of paint adapted to enable enhanced-continuously-fed roller painting by the user, and a manually actuatable valve adapted for use allowing feeding of paint into the roller frame.

### CONTINUITY AND CLAIM OF PRIORITY

This application claims the priority and benefit of U.S. Patent Application No. 63/005,295, filed Apr. 4, 2020.

### FIELD

The present invention relates to an improved paint roller system for supplying paint to a paint roller, and more particularly to an improved paint roller system, whether for manual or battery-powered use, for supplying paint carried in a container able to be carried with a backpack and to a roller on the end of an extended handle, the system being capable of being manufactured independently, or alternatively of being made of existing, but modified, components, modified to suit a purpose of quickly and efficiently supplying latex or oil-based paint to a long-handled roller, to greatly reduce the time and effort needed to apply paint using the roller to larger, difficult to reach, surfaces as are regularly encountered in a commercial painting context.

### BACKGROUND

Using a roller system comprising an absorbent sleeve on a cylindrical body rotatably mounted on a tubular or wire handle, to paint larger surfaces is known in the prior art, and using an extended pole to further facilitate doing so is likewise known in the prior art. With such long-handled systems, users have been enabled in more quickly painting even tall walls traditionally out of reach of the user without the use of a stepladder. However, such systems have been somewhat cumbersome, since users have had to very frequently re-dip, or re-roll, the roller, traditionally in a pan of paint to coat the absorbent roller sleeve, to make sure there has been an adequate supply of paint on the roller sleeve in order to adequately cover by rolling the roller sleeve along the surface to be painted. And thus, the desirability of a more continuously-fed roller system had become apparent.

To facilitate roller painting systems generally, there has been developed in the prior art a system for more continuously supplying paint from a reservoir through a handle to a roller using pressurized air, as taught in U.S. Pat. No. 2,751,618, to Pruitt. With Pruitt the paint had been supplied through the handle and through perforations in a hollow supply tubing armature located underneath the roller that had been rotatably carried on the hollow supply tubing. Thus, as pressurized air forced paint through the perforations into a cavity formed by the roller and end caps around the supply tubing, the roller material became saturated enabling more continuous applying paint coming through the roller and onto a surface. Since Pruitt taught the use of compressed air, requiring a larger compressor and pressurized air lines, it has been considered less portable.

To address the issue of lack of portability in such a more continuously-fed paint roller system, there has been developed in the prior art a system of more continuously supplying paint to a roller via a curved tubular conduit communicating via a valve assembly with a paint handle-contained reservoir having a paint pushing piston rod therein, as taught in U.S. Pat. No. 3,702,739, to Rentfrow. With Rentfrow, the user is enabled in portable, semi-continuously-fed rolling with a portable roller painting system, since it supplied a manually actuated plunger to force paint from the reservoir handle into an interior portion of the roller via perforations in the tubular conduit underneath the roller. Like Pruitt, the paint was then allowed to be absorbed into the sleeve of the roller for semi-continuous application of paint to the surface via the roller, semi-continuous in the sense that the user had to manually actuate the plunger to get more paint onto the roller, semi-continuous in the sense that the user had to use both hands to activate the manually-activated plunger to push more paint into the roller, and semi-continuous in the sense that the user had to frequently fill the handle over and over, thus necessitating downtime, before additional use was possible. To the extent that Rentfrow contemplated the use of an air compressor, i.e., with a pressurized hose attached, it has also been considered less portable.

These advancements in the prior art enabled the convenience of supplying additional paint at least more continuously, or semi-continuously, to the roller while the roller has been in use, thus facilitating somewhat more efficient painting. However, these advancements were limited in the sense that they were less portable, in the case of needed compressed air delivered by an air hose, or they provided less continuous painting in the case of the handle-reservoir system of Rentfrow, since there was a lesser amount of paint that could be contained in the limited length of the handle, and the user was required to use both hands to activate the plunger to push more paint into the roller. This latter fact contributed to the lesser suitability of a portable solution such as Rentfrow for larger paint jobs, and the need for two hands to press paint into the roller rendered Rentfrow less suitable for continuous painting, because the user was too busy trying to press paint into the roller with the plunger to focus on painting with a free hand. And these facts further exacerbated the fact that filling the handle of Rentfrow had been cumbersome and got in the way of more continuous painting.

To deal with difficulties associated with filling the handle reservoir, in U.S. Pat. No. 7,556,447, to Bruggeman et al., there was provided a fill tube for more easily drawing paint from a paint can up into the tube of a handle reservoir supplied paint roller. Further, Bruggeman et al. taught a helical groove on the plunger for forcing paint retained in the handle reservoir into the paint roller. Nevertheless, the Bruggeman device was still somewhat limited in capacity by the length of the handle, and this led to additional effort, as with the Rentfrow device, requiring more frequent refilling of the handle reservoir. Further, like the Rentfrow device, Bruggeman et al. also required both hands to force more paint into the roller—an action that was not conducive to more continuously effortless rolling of paint onto the surface. Further, Bruggeman clearly was not well-suited for larger paint jobs because of the frequent need for refilling of the reservoir.

Addressing the lack of portability in the Pruitt prior art roller system, and to allow supply of somewhat more paint than was feasible with the Rentfrow system, there has been developed a Weathershield backpack paint roller system by Dulux. The Dulux system allows for portable carrying of a specially-designed paint pack in the backpack, and the user is enabled in attaching a power unit to the specially-designed paint pack, together with a dip tube, for trigger-fed power assisted drawing of paint into a flexible hose for supplying paint to the roller. Thus, the Dulux system provided somewhat more continuous painting capability than Rentfrow, but the Dulux system only provided about a gallon of paint, at the most, and there was also the drawback that the Dulux system required a special, smaller, paint pack, requiring more frequent changes and less convenient use of only certain types of paint available in such a pack. Or, alternatively, the user has been required to re-fill the special pack more often owing to the fact that it is a smaller form factor. Thus, the Dulux system was also been somewhat limited in being able to provide more continuously-fed paint to a roller for larger, for example commercial, paint jobs.

The Dulux system provided an optional extension pole for attaching to the roller for harder-to-reach places. However, it was still advertised with the use of a ladder, it being the case that the Dulux system also provides for hands-available climbing of the ladder with a roller holder accessory to be located on the front of the backpack near the chest of the user. For these reasons, i.e., the need for a lower-capacity special paint pack, and an apparently more suitable shorter handle, the Dulux system is not considered ideally suited for larger commercial jobs.

Thus, there has been needed an enhanced portability, enhanced continuously-fed, backpack paint roller system not requiring special equipment for implementation. Such a system will preferably be easy to fill, easy to clean, and in an embodiment able to be constructed relatively easily of otherwise readily available components.

### SUMMARY

In accordance with an aspect of the disclosure, there is provided an improved, higher-capacity, portable, enhanced continuously-fed, paint roller system, comprising: a portable container adapted for being filled with, and for carrying around a jobsite, more than a gallon of paint; shoulder straps attached to the portable container; a porous paint roller having first and second ends, an inner roller structure, and an outer roller material, the roller adapted for allowing paint to absorb into the outer roller material for rolling application to a surface; a roller conduit frame having perforations therein for allowing paint to pass through the perforations into an interior space defined between the roller and the roller conduit frame, the roller conduit frame defining a channel for feeding paint through the perforations into the interior space for absorption by the roller; a plurality of sealing cap members adapted for interconnecting and partially sealing the ends of the roller on and around the roller conduit frame; an elongated handle member interconnected with the roller conduit frame; a flexible conduit hose leading from the container to, and communicating between, the frame and the container; means adapted for enhanced continuous pressurization of paint within at least a portion of the container, without requiring loss of dexterity with a longer pole preventing enhanced continuous painting, so that the paint is manually forced through the frame and the frame's perforations into the interior space for absorption by the roller, and adapted to enable enhanced-continuously-fed roller painting by the user; and a manually actuatable valve adapted for use allowing feeding of paint into the frame.

The paint roller system in accordance with this aspect of the disclosure, preferably further comprises a reinforced pressure well communicating with the container, for example sitting on top of the container and interposed between the container and the flexible conduit. Further, preferably, the paint roller system in accordance with this aspect of the disclosure provides that the means adapted for enhanced continuous pressurization of paint comprises a single hand-operable manual lever for pressurizing the pressure well while being adapted for leaving another of a user's hands free to operate the roller via the handle.

In an embodiment of this aspect of the disclosure, the paint roller system may further comprise a belt attached to the container and adapted for securing the container around a user's waist. Further, the paint roller system may be provided wherein the hand-operable lever is located and extends from a location low on the container, the hand-operable lever extending forward sufficiently far to enable easy compression by the user's hand by pressing in a direction well below shoulder level of the user, with or without the aforementioned belt adaptation.

Preferably, in accordance with this embodiment, the paint roller system is provided wherein the hand-operable lever is located and extends from a location low on the container, the hand-operable lever extending forward sufficiently far to enable easy compression by the user's hand by pressing in a direction well below shoulder level of the user.

In accordance with an embodiment of this aspect of the disclosure, the paint roller system may be provided wherein the container and the hand-operable lever are adapted from a commonly available sprayer container modified by enlarging orifices of the sprayer, commonly available flexible hosing specially adapted for interconnecting with the enlarged orifices of the sprayer with a heat-treated adapting hose insert and o-ring combination, adapted for sealed communication of paint from the commonly-available liquid sprayer before only suited for much less viscous fluids, such as pesticides or weed killer.

In accordance with this aspect of the disclosure, in an embodiment thereof, the elongated handle may be extensible from between longer than one meter to longer than two meters, the handle likewise being retractable from longer than two meters to longer than one meter, all without paint leaking to outside of the handle. Thus, in order to retract the handle, there is provided a pressure release valve in the container, or its pressurized portion, to enable excess paint to flow back into the container upon retraction of the handle.

In accordance with another aspect of the disclosure, the paint roller system may provide that the means adapted for enhanced continuous pressurization of paint comprises a battery-powered pump for pressurizing at least a portion of the container. In accordance with an embodiment of this aspect of the disclosure, the paint roller system may be provided wherein the container and the battery-powered pump are adapted from a commonly available sprayer container adapted for use with paint by enlarging orifices of the sprayer, commonly available semi-flexible hosing specially adapted for interconnecting with the enlarged orifices of the sprayer with a heat-treated adapting hose insert and o-ring combination, adapted for sealed communication of paint from the commonly-available liquid sprayer before only suited for much less viscous fluids, such as pesticides or weed killer.

Alternatively, in accordance with either aspect of the disclosure, the paint roller system may provide that paint may travel through an elongated, preferably extensible and retractable, handle preferably longer than one meter long. Thus, in accordance with these embodiments and aspects of the disclosure, there is provided a paint roller system wherein the handle is over a meter long to facilitate enhanced continuous paint rolling in hard-to-reach areas without a ladder.

Thus, in an embodiment, and in accordance with any of the foregoing aspects of the disclosure, the paint roller system is provided wherein the flexible conduit hose comprises a coiled semi-flexible hose able to extend and retract to accommodate the variously retractable and extensible handle. In this embodiment, the paint need not flow through the handle, thus facilitating cleaning of the system and allowing for simpler construction of the system.

Thus, in accordance with one or more aspects, and in an embodiment, of the disclosure, there is provided an improved, higher-capacity, portable, enhanced continuously-fed, paint roller system, comprising: a portable container adapted for being filled with, and for carrying around a jobsite, more than a gallon of paint; shoulder straps attached to the portable container; a porous paint roller having first and second ends, an inner roller structure, and an outer roller material, the roller adapted for allowing paint to absorb into the outer roller material for rolling application to a surface; a roller conduit frame having perforations therein for allowing paint to pass through the perforations into an interior space defined between the roller and the roller conduit frame, the roller conduit frame defining a channel for feeding paint through the perforations into the interior space for absorption by the roller; a plurality of sealing cap members adapted for interconnecting and partially sealing the ends of the roller on and around the roller conduit frame; an elongated handle member interconnected with the roller conduit frame; a semi-flexible conduit hose leading from the container to, and communicating between, the frame and the container; a manual hand pump adapted for enhanced continuous pressurization of paint within the container so that the paint is manually forced through the frame and the frame's perforations into the interior space for absorption by the roller and further adapted to enable enhanced-continuously-fed roller painting by the user; and a manually actuatable valve adapted for use allowing feeding of paint into the frame.

Still further, in accordance with one or more aspects, and in an embodiment, of the disclosure, there is provided an improved, higher-capacity, portable, enhanced continuously-fed, paint roller system, comprising: a portable container adapted for being filled with, and for carrying around a jobsite, more than a gallon of paint; shoulder straps attached to the portable container; a porous paint roller having first and second ends, an inner roller structure, and an outer roller material, the roller adapted for allowing paint to absorb into the outer roller material for rolling application to a surface; a roller conduit frame having perforations therein for allowing paint to pass through the perforations into an interior space defined between the roller and the roller conduit frame, the roller conduit frame defining a channel for feeding paint through the perforations into the interior space for absorption by the roller; a plurality of sealing cap members adapted for interconnecting and partially sealing the ends of the roller on and around the roller conduit frame; a hollow elongated handle member having first and second ends and comprising a conduit adapted for fluid communication at the second end of the handle with the frame; a flexible hose adapted for fluid communication between the container and the first end of the handle; a battery-powered pump adapted for enhanced continuous pressurization of paint within the container so that the paint is adapted to be forced from the container, through the flexible hose, through the handle, and through the frame and the frame's perforations into the interior space for absorption by the roller to be further adapted to enable enhanced-continuously-fed roller painting by the user; and a compression-type lever actuatable valve adapted for use allowing feeding of paint into the frame. Preferably, the paint roller system of in accordance with this embodiment wherein the handle is variably retractable and extensible to longer than one meter.

The improved paint roller system in accordance with the foregoing aspects and embodiments addresses the shortcomings of the prior art systems, providing simultaneously for a portable backpack enabled paint roller system, wherein the system supports enhanced continuous rolling capability, owing to an improved manual pressurization design and extensible handle capability, whether paint flows directly to the roller frame, or through the extensible handle itself.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings wherein like reference characters refer to like elements.

### BRIEF DESCRIPTIONS OF DRAWINGS

FIG. 1 is a front perspective view of an improved, higher-capacity, portable, battery-powered, enhanced continuously-fed, paint roller system in accordance with an aspect and embodiment of the disclosure;

FIG. 2 is a close-up perspective view of a lockable paint-flow control lever and valve system, and optional supply adaptor, for the system shown in FIG. 1;

FIG. 3A is a close-up perspective view of an on-off switch linked with an extensible/retractable handle portion of the system, wherein paint is adapted to flow through the handle depending upon whether the switch is in an on, or an off, position;

FIG. 3B is a close-up perspective view of an embodiment of a leak-proof extensible/retractable handle adaptor also suitable for enabling interconnection of multiple sections of handle, wherein paint is adapted to flow through the extensible/retractable handle;

FIG. 3C is a close-up perspective internal view of a threaded interconnection for a hollow extensible/retractable handle wherein paint is adapted to flow through the handle;

FIG. 3D is a close-up perspective internal view of a threaded handle interconnection for the hollow extensible/retractable handle of FIGS. 3A-3C;

FIG. 3E is a close-up perspective view of mating threaded handle interconnections for the hollow extensible/retractable handle of FIGS. 3A-3D;

FIG. 4 is a close-up front perspective view of an embodiment of a backpack-enabled paint container with a battery-powered motor to pressurize pump paint into a paint supply hose;

FIG. 5 is a rear perspective view of the backpack-enabled paint container portion of FIG. 4;

FIG. 6 is a front perspective view of another embodiment of an improved, higher-capacity, portable, manually-powered, enhanced continuously-fed, paint roller system in accordance with an aspect of the disclosure;

FIG. 7 is a perspective view of the roller, extendible pole, and paint supply portions of the paint roller system of FIG. 6;

FIG. 8 is a rear perspective view of the backpack-enabled paint container portion of FIG. 6;

FIG. 9 is a side perspective view of the backpack-enabled paint container portion of FIG. 6, with a coiled paint supply hose connected thereto and a manual hand-pump pressurization lever pivotably mounted near the base of the container;

FIG. 10 is a top perspective view of a hollow perforated roller frame member adapted for carrying a rotatable paint roller member thereon and for connection to an extensible/retractable paint roller handle;

FIG. 11 is a top perspective view of the hollow perforated roller frame member of FIG. 10, together with the rotatable roller member, an internal baffle for better control of paint once pumped into the roller; and end caps for sealing the ends of the rotatable roller member around the perforated roller frame member;

FIG. 12 is a top perspective view of a portion of a flexible paint supply hose having a valve control lever on one end and a connection system on the other end adapted for interconnecting the supply hose and the paint container portion;

FIG. 13 is a close-up perspective view of a type of threaded coupling device as part of an interconnection system for interconnecting the paint supply hose with the roller frame member at one end of the supply hose and the paint container at the other end of the supply hose;

FIG. 14 is a close-up perspective view of a universal type, multi-angle, clamp for interconnecting the roller frame member with an extensible/retractable handle;

FIG. 15 is a close-up perspective view of a threaded coupling device and interconnection system combination for interconnecting the paint supply hose with the roller frame member at one end of the supply hose and the paint container at the other end of the supply hose;

FIG. 16 is a close-up rear perspective view of the container with a pressurized portion having a hand-operated manual pump attached thereto, together with a coiled paint supply hose interconnected with the pressurized portion;

FIG. 17 is a close-up perspective view of a threaded coupling device and interconnection system combination, together with the threaded paint supply outlet for interconnecting the paint supply tube with the pressurized portion of the paint container; and

FIG. 18 is a front perspective view of the paint container, manual pump, pressurized paint portion, and manual pump lever, portions of the improved, higher-capacity, portable, battery-powered, enhanced continuously-fed, paint roller system in accordance with an aspect and embodiment of the disclosure.

### DETAILED DESCRIPTION

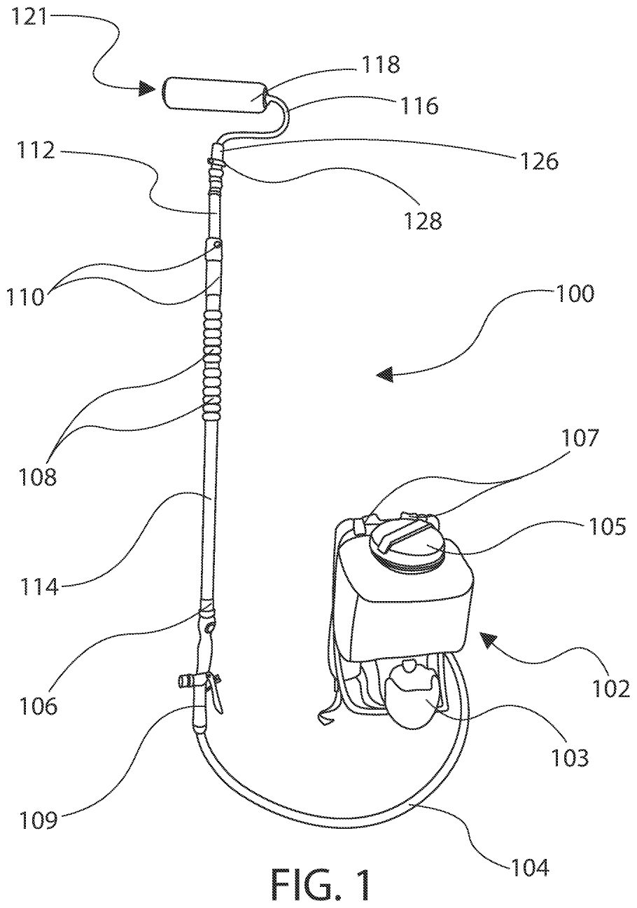

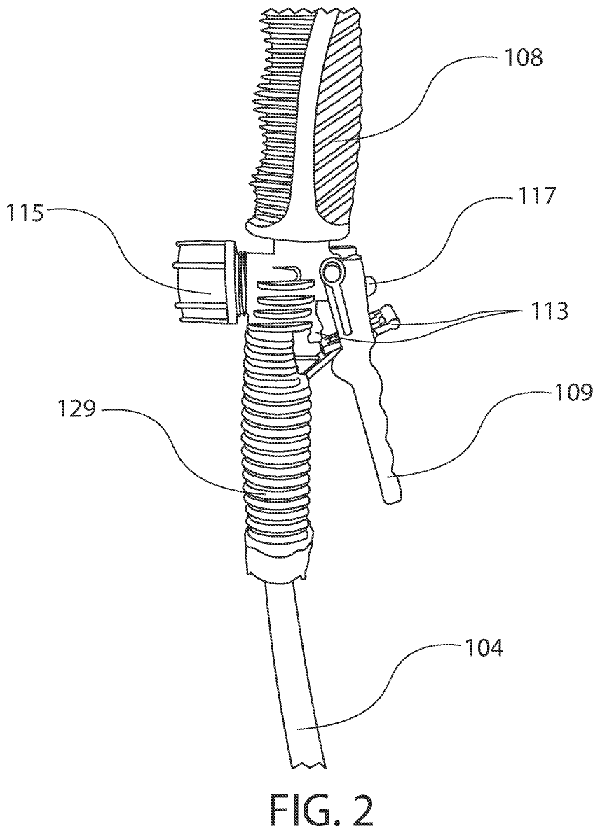

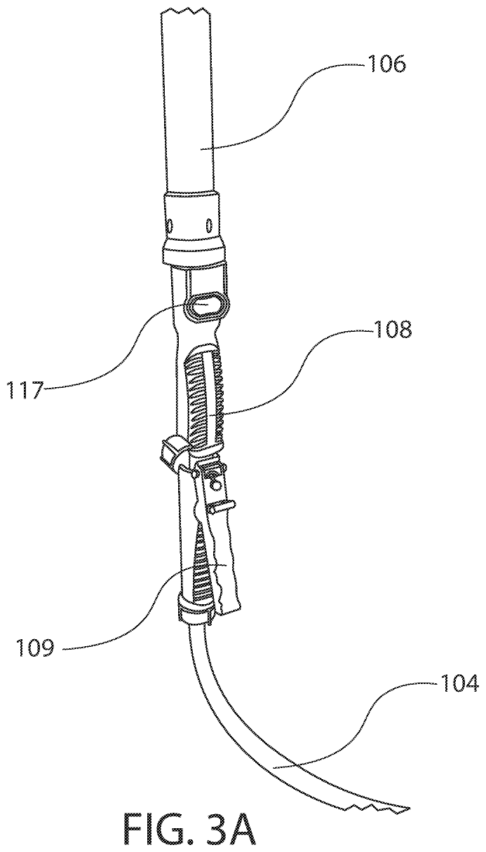

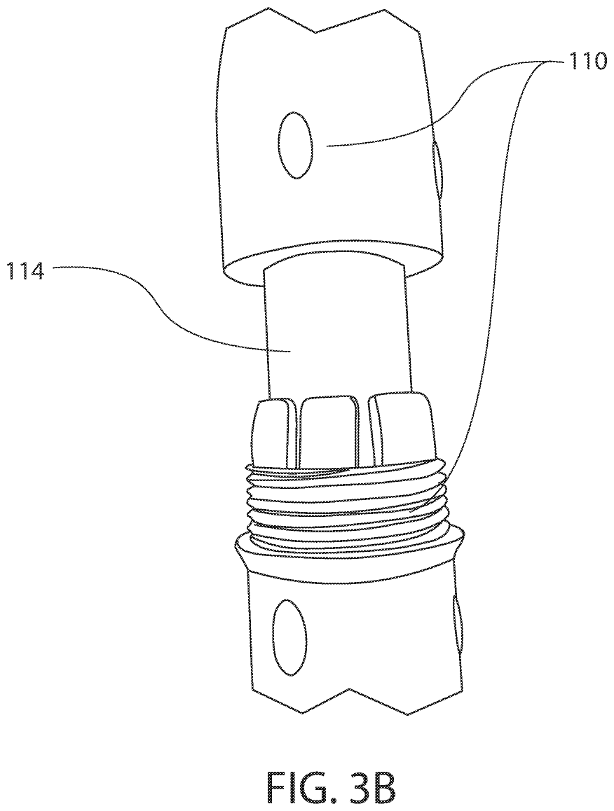

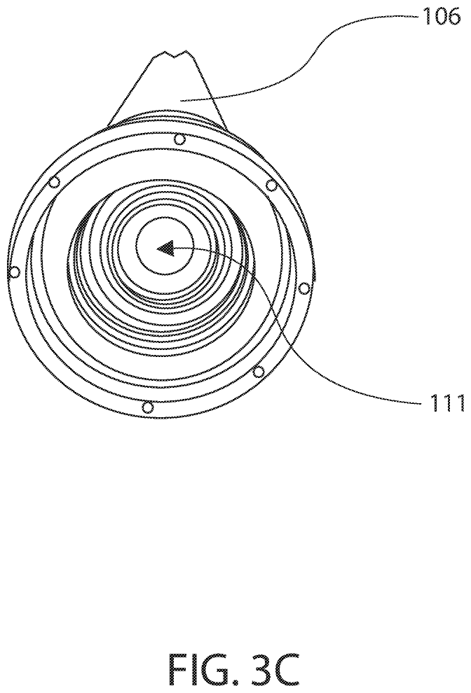

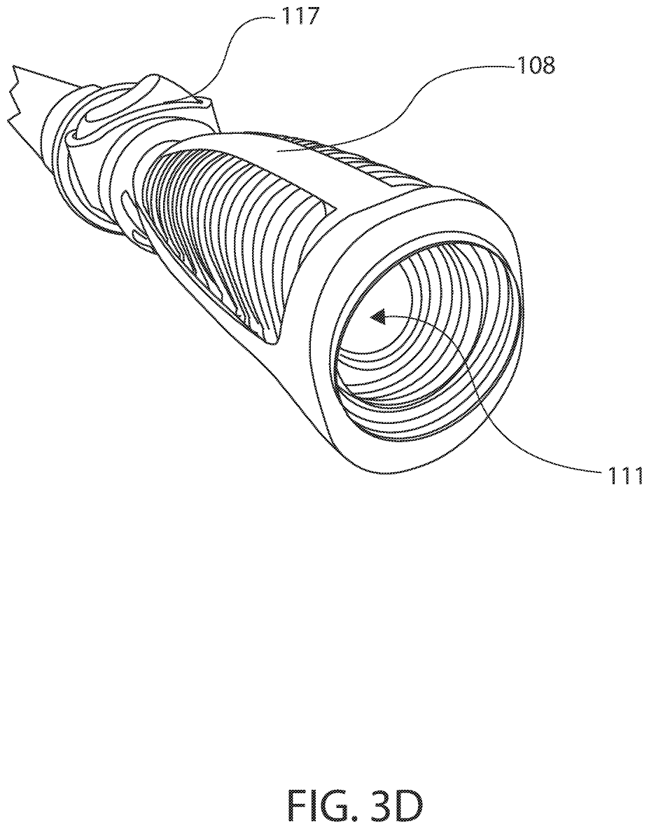

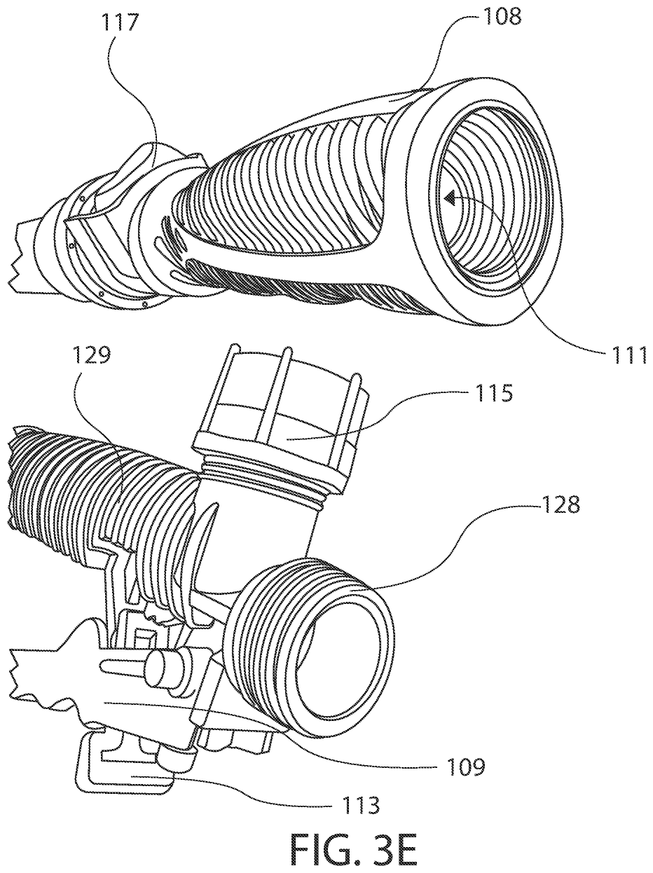

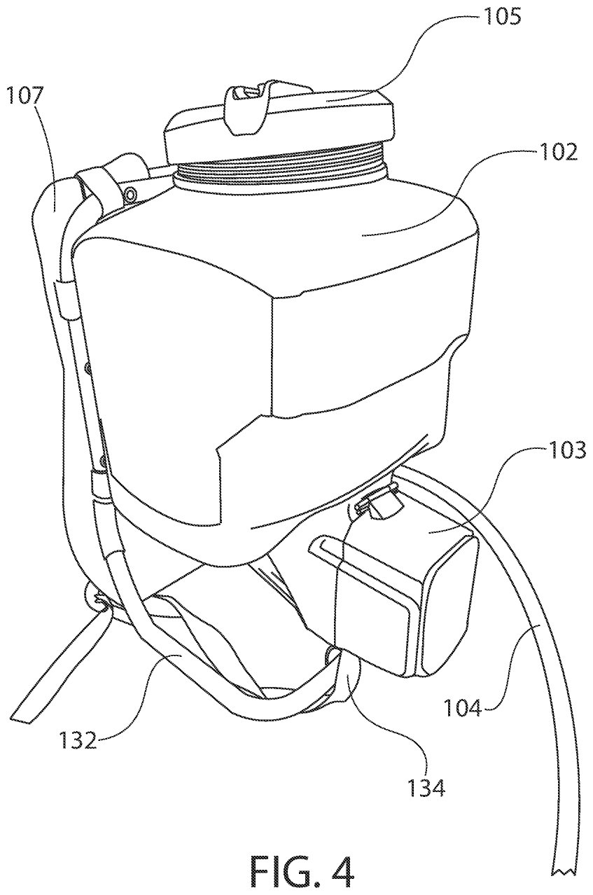

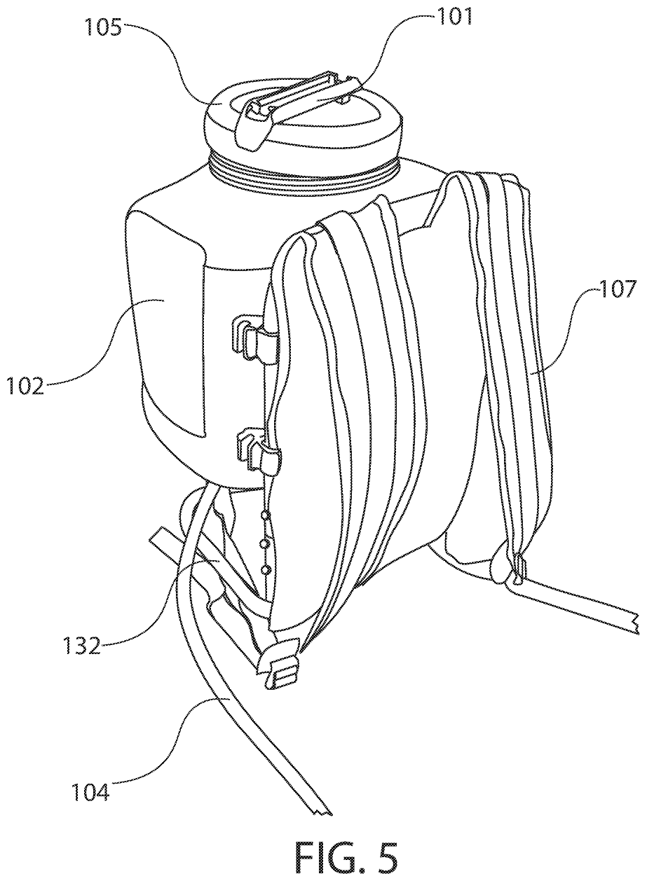

Referring to FIGS. 1-5 and 12-13, there is provided an embodiment of a backpack-paint-carrying-enabled, higher-capacity, long-extensible-handled, enhanced-continuous-feed paint roller system 100, in accordance with one or more aspects of the disclosure. The, system 100 comprises a higher-capacity container 102 capable of holding over a gallon of common latex or oil-based paint, and preferably may be adapted from an existing battery-powered pump 103 insecticide or week-killer sprayer, such as an off-the-shelf, commercially available, Ryobi® backpack sprayer adapted by enlarging fluid communication ports thereof in the output from the container 102. The system further comprises a longer extensible handle 106, between one and two meters when retracted and extensible up to between 1.7 to 3.5 meters when extended. The handle 106 is interconnected with the container 102 with a flexible hose 104, and may be comprised of a commercially-available extensible wand such as may be fitted with threaded fittings onto a garden hose, whereas the end of the handle that is adapted to be adjacent the roller comprises a commonly-available threaded connector commercially available for threaded attachment of a brush on the end of the handle, as is available for washing cars. A threaded fitting 130 of the flexible hose 104 is contained in a handle in a handle hose end 129 carrying the lever 109 and a part of the locking latch 113. This handle hose end 129 may be detachable for easy storage and cleaning.

The container 102 comprises a twist-off cap covering and opening 105 for enabling filling of the container with paint. The container 102 is carried on a frame 132 and further comprises shoulder straps 107, enabling carrying of the container full of paint as a backpack. An optional lap belt 134 may be provided for further securing the container 102 on a user's hips to further support increased loads. The extensible handle 106 preferably has grips 108, and a twisted threaded release mechanism 110 for enabling extending an retracting of the handle 106 via telescoping means with one section 112 of the handle nested in another section 114 of the handle during a retracted state.

The handle 106 further comprises a lockable (at latch and catch 113) actuating lever 109 for operating a valve 115 enabling paint to feed through the hose 104 and into a hollowed-out portion 111 of the handle through a channel 116. An extra safety button 117 is also provided either on the handle 116 or on the handle hose end 129 to avoid mistaken lever and valve actuation.

A pressure-fed curved, hollow, perforated, paint roller frame 116 is provided for rollably carrying a paint roller member 118, the roller member having an inner porous structure and an outer absorbent member as is known in the art. Two end caps 120 are provided for sealing a cavity 121 formed between the roller member 118 and the roller frame 116, and there may be provided a baffle 122 interposed in the cavity between the roller frame and the roller member to prevent excess paint and undue flow of paint. The paint roller frame 116 comprises perforations 124 for allowing paint to flow into the cavity 121. The paint roller frame 116 is adapted for being connected with a threaded connector 126 that is adapted to tighten down on a matching threaded end of the 128 of the extensible handle 106. A ball and socket relationship 130 is provided where necessary, for example between the frame 116 and the handle 106, as well as at other locations in the system such as interconnecting of ends of the hose 104 to the container 102 and the handle 106, where a good seal is required to prevent leakage of paint.

Any valves within the system, whether in the container or in the handle, must be enlarged as with a drill press to allow passage of a more viscous fluid, such as latex or oil-based paint as compared with water, typical liquid pesticides, or typical liquid herbicides.

Once the container 102 is filled with paint, the user may turn the battery-powered pump 103 on via a handle actuated switch 117, engage the lever 109 and latching lock 113 as necessary, and thereby feed paint through the handle 106, into the roller frame 116, through the cavity 121, and into the roller 118 for enabling enhanced continuous rolling capability. The enhancement-continuous painting capability over prior powered rolling devices is that the handle is longer and extensible (lessening the need to interrupt painting to climb up and down ladders), the container is backpack enabled, lessening the need to interrupt painting to go back to re-roll the paint roller using prior longer-handled non-continuous feed-type paint rolling systems, and the container is enlarged (e.g., up to four gallons of paint), lessening the need to interrupt painting as often to fill a smaller container. Surprisingly, the enhanced continuous roller painting system greatly reduces the time necessary to complete even larger paint jobs. And clean up is easily accomplished whether with water, for latex paints, or spirits traditionally used for cleaning oil-based paints from a traditional paint sprayer device.

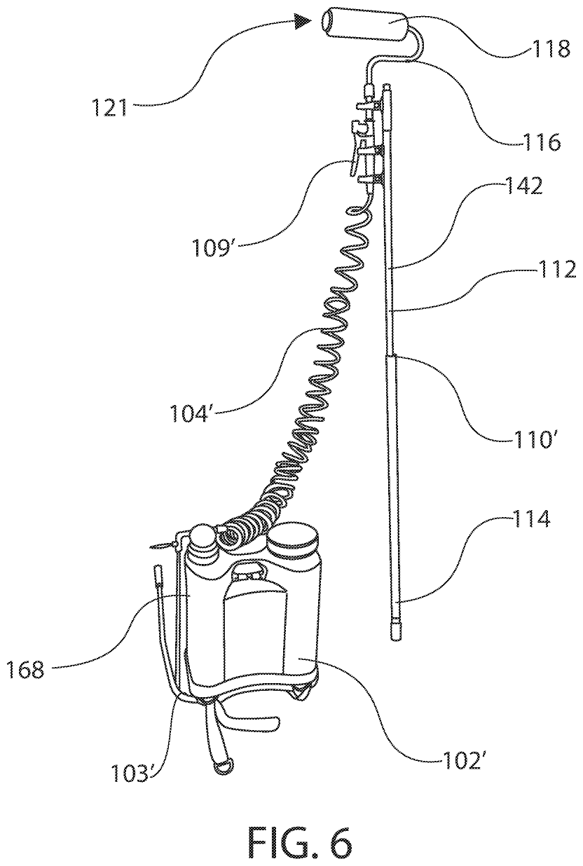

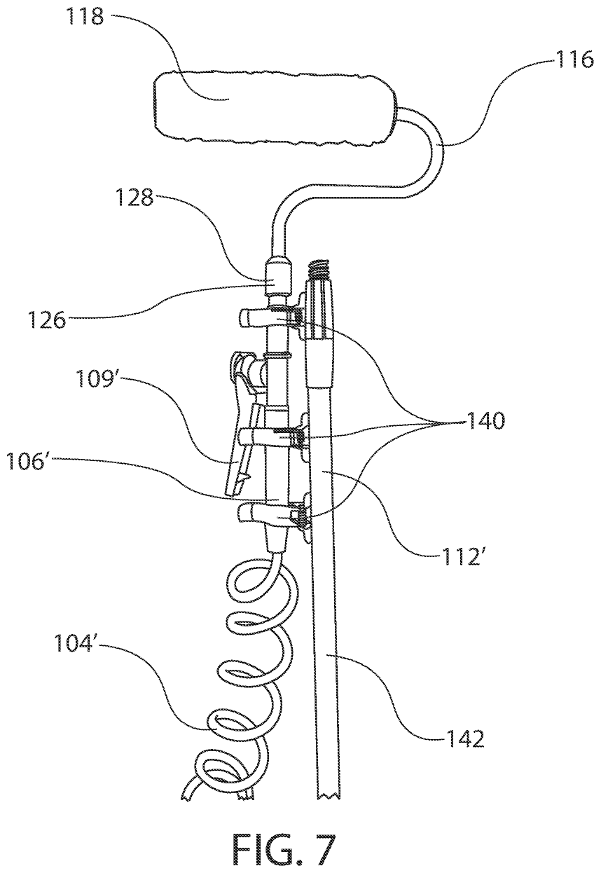

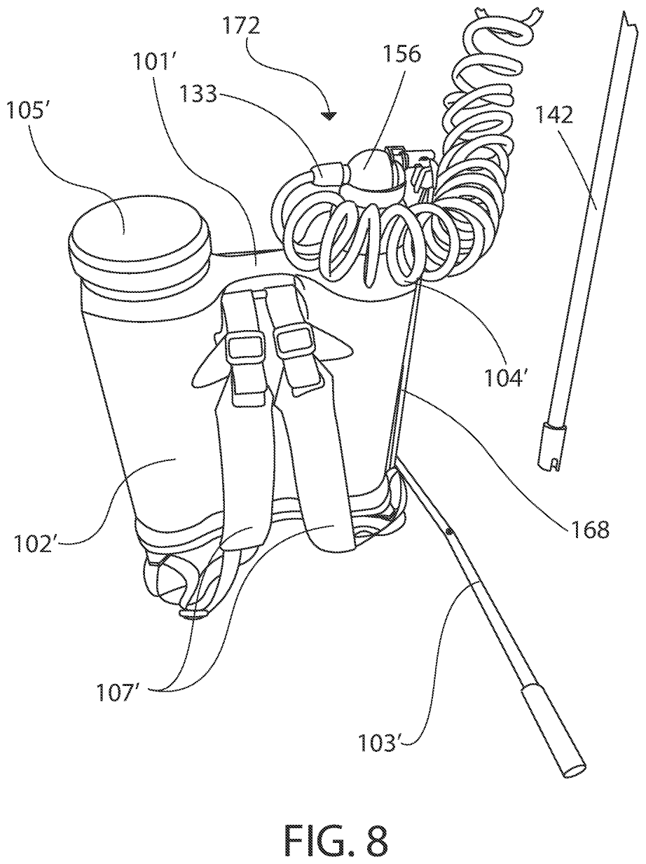

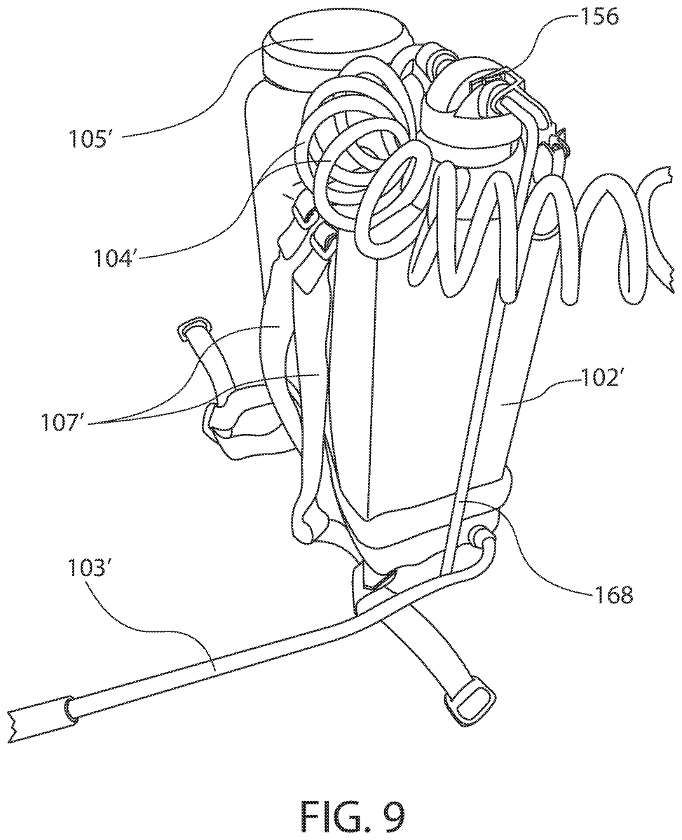

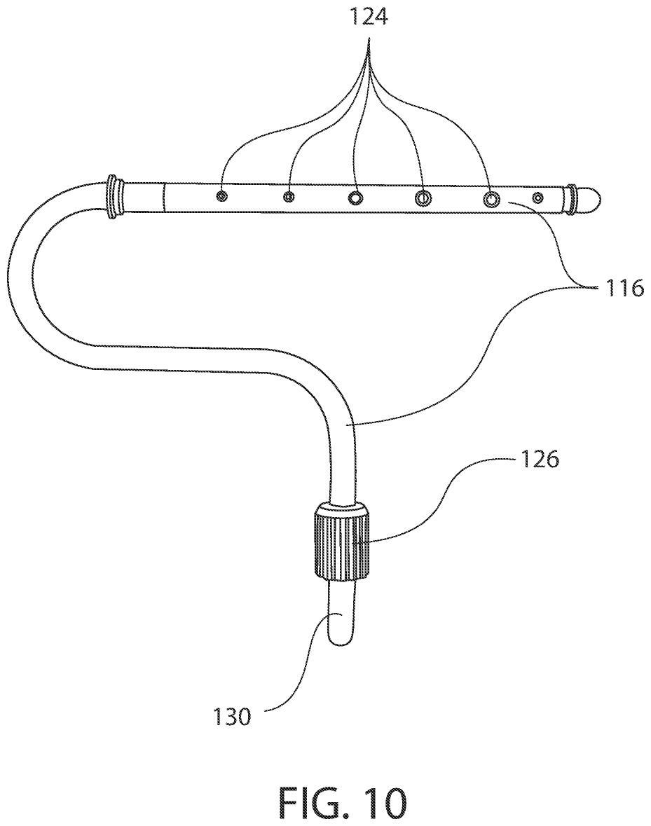

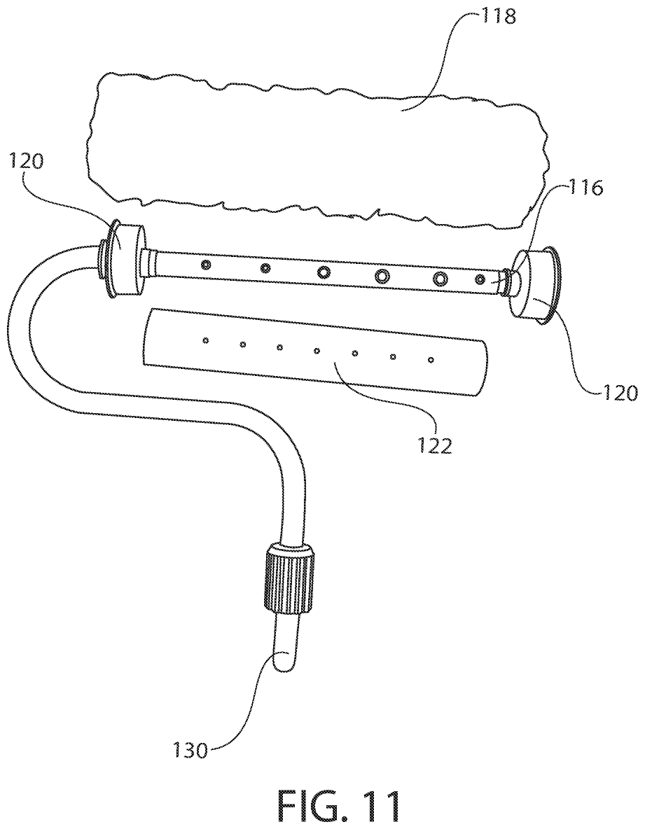

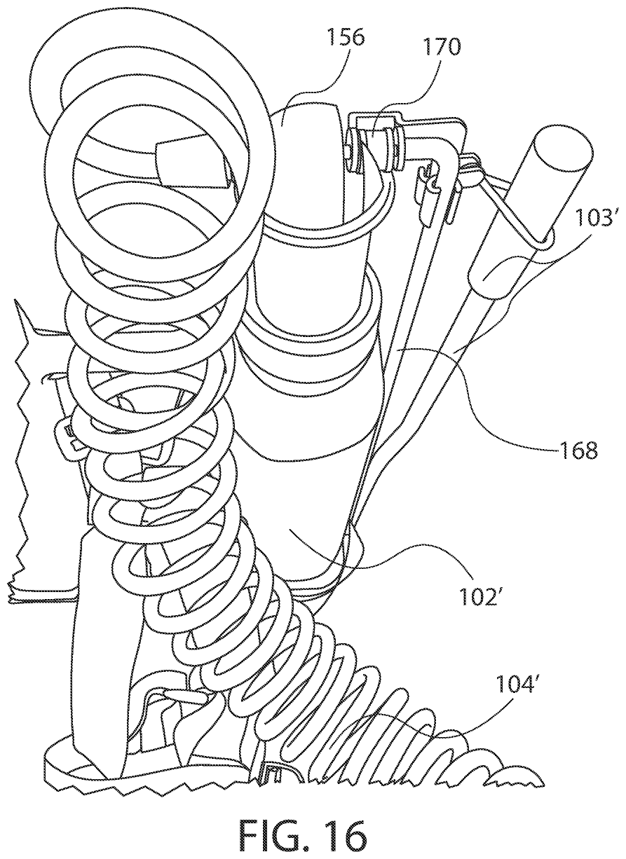

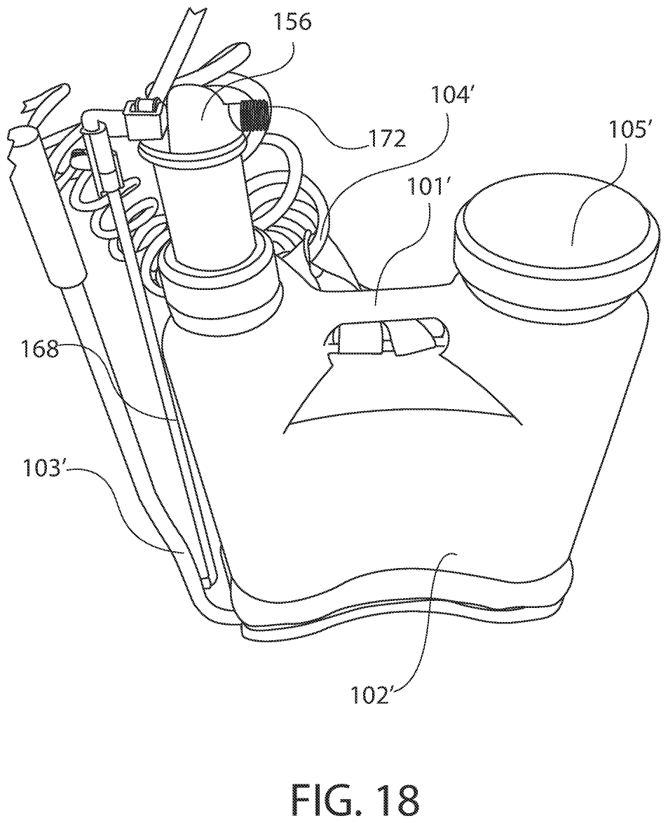

Referring now to FIGS. 6-11 and 14-18, there is provided another embodiment of a backpack-paint-carrying-enabled, higher-capacity, long-extensible-handled, enhanced-continuous-feed paint roller system 100′, in accordance with one or more aspects of the disclosure. One difference between the system 100 and the system 100′, is that the latter does not feed paint through a hollow handle, but rather a commonly-available coiled hose that interconnects with an available roller frame 116′ attached atop an extensible pole 142 as further described below.

The system 100′ comprises a higher-capacity container 102′ capable of holding over a gallon of common latex or oil-based paint, and preferably may be adapted from an existing hand-powered pump 103′ insecticide or week-killer sprayer, such as an off-the-shelf, commercially available, backpack sprayer adapted by enlarging fluid communication ports thereof in the output from the container 102′. The system further comprises a longer extensible pole 142, between one and two meters when retracted and extensible up to between 1.7 to 3.5 meters when extended. The shorter handle 106′ of this embodiment is interconnected with the container 102′ with a coiled flexible hose 104′, and the handle may be comprised of a commercially-available handle attached to a powered roller system not having an extensible handle, such as that available with the Dulux system described previously herein. The pole 142, however, may be such as may be used for other paint roller extension handles not having been adapted for enhanced-continuous feed roller painting.

A threaded fitting 130′ of the coiled flexible hose 104′ is contained in a hose end 131′. The lever 109′ in this embodiment may likewise embody a locking latch 113, which may be important for this embodiment, since the paint roller frame 116′ for this embodiment is attached to a second end of the extensible handle, or pole, 106′, via a plurality of clips 140.

The container 102′ comprises a twist-off cap covering and opening 105′ for enabling filling of the container with paint. The container 102′ is rigid and the system 100′ further comprises shoulder straps 107′ extending from the container, enabling carrying of the container full of paint as a backpack. An optional lap belt (not shown) may be provided for further securing the container 102′ on a user's hips to further support increased loads. The extensible handle 106′ preferably has a twisted threaded release mechanism 110′, operable by counter-rotating sections 112′ and 114′ of the handle for enabling extending an retracting of the handle 106′ via telescoping means with one section 112′ of the handle nested in another section 114′ of the handle during a retracted state. The container 102′ may also be provided with a handle 101 (in the case of the first embodiment for helping with twisting off the cap 105 for paint filling), or 101′ (in the case of the second embodiment for allowing picking up, or lugging, of the container 102′).

In this embodiment 100′, the actuating lever 109′ is attached to a smaller handle 106′ that is part of the paint roller frame member 116′, and the actuating lever 109′ further comprises a lockable (at latch and catch 113′) actuating lever 109′ for operating a valve 115′ enabling paint to feed through the coiled hose 104′ and into a hollowed-out portion 111′ of the smaller handle through a channel 116. An extra safety button 117′ may also provided either on the handle smaller handle 106′ to avoid mistaken lever and valve actuation.

The embodiment of system 100′ comprises the same type of pressure-fed curved, hollow, perforated, paint roller frame 116 for rollably carrying a paint roller member 118, wherein the roller member also has an inner porous structure and an outer absorbent member as is known in the art. As with the first embodiment, there are further provided two end caps 120 for sealing a cavity 121 formed between the roller member 118 and the roller frame 116, and as described earlier, there may be provided a baffle 122 interposed in the cavity between the roller frame and the roller member to prevent excess paint and undue flow of paint. The paint roller frame 116 comprises perforations 124 for allowing paint to flow into the cavity 121. The paint roller frame 116 may be adapted for being connected with a threaded connector 126 that is adapted to tighten down on a matching threaded end of the 128 of the shorter handle 106′ or longer handle 106. Thus, it will be appreciated that the various components of the two embodiments described herein may be intermixed and matched as necessary to achieve desired flexibility and results.

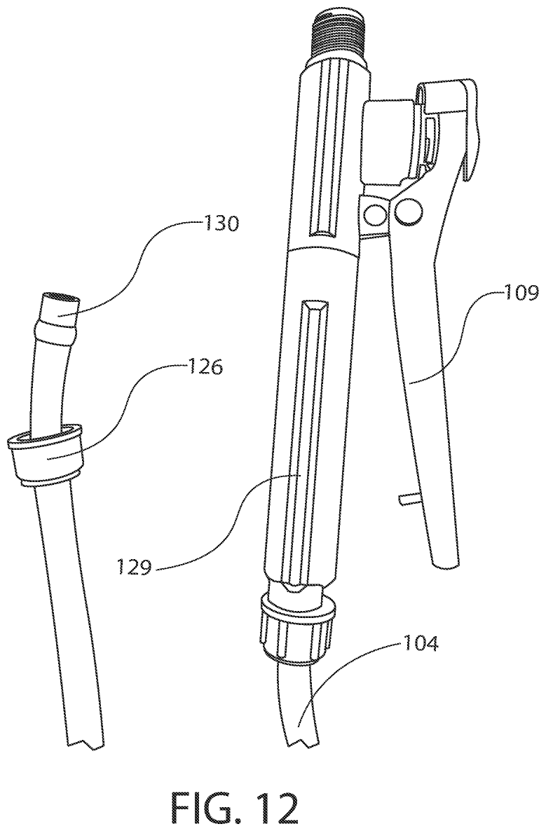

Referring to FIGS. 12, 13, and 15, a ball-and-socket-type relationship 130 is also provided with this embodiment where necessary, for example between the frame 116 and the handle 106′, as well as at other locations in the system such as interconnecting of ends of the coiled hose 104′ to the container 102′ and the smaller handle 106′, where a good seal is required to prevent leakage of paint. This ball-and-socket-type relationship 130 is provided in novel fashion by heating of the coiled flexible hose to enable insertion of a sealed ball-type transition member 135 into the hose 104′ and adapted for nesting with a correspondingly concave, partial bowl-shaped, receptacle, or socket member, 145, 145′, all as further described herein, to allow adaptation of an otherwise commercially available garden sprayer to a higher-capacity, enhanced continuous, powered roller painting system 100, 100′.

Thus, any valves within the system, whether in the container or in the handle, must be enlarged as with a drill press to allow passage of a more viscous fluid, such as latex or oil-based paint as compared with water, typical liquid pesticides, or typical liquid herbicides, and the aforementioned adaptation must be applied in a novel manner so as to adapt the commercially-available garden sprayer to become a pressurized paint rolling system 100, 100′.

The embodiment of system 100′ further comprises a hand-actuated pump lever handle 154, the handle adapted for actuating a linkage in turn for actuating a manually-operable pump 103′ to pressurize a pressurized cylinder 156 located atop the container 102′. Thus, paint is fed through enlarged openings of a commercially-available garden sprayer with a pump handle 103′, and is pressurized in the pressurized cylinder 156 to enable feeding of paint through the coiled hose 104′, and up to the shorter handle 106′. Unlike the first embodiment of the system 100, the system 100′ uses the coils in the hose 104′ to further facilitate extensibility of the pole 142 without overstressing the hose 104′ Since the hose 104′ is coiled, as the pole 142 is retracted, the hose simply recoils so as to stay out of the way of the user.

Thus, once the container 102′ is filled with paint, the user may pressurize the cylinder 156 by actuating the pump handle 103′ carried on the container 102 and then, or before to simply pump paint into the roller, engage the lever 109′ and latching lock 113′ as necessary, and thereby feed paint through the coiled hose 104′ into the shorter handle 106′, into the roller frame 116, through the cavity 121, and into the roller 118 for enabling enhanced continuous rolling capability.

The enhancement-continuous painting capability of the present embodiment over prior powered rolling devices (employing battery-powered, or manual twist-handle pressurized poles) is that the handle is longer and extensible, lessening the need to interrupt painting to climb up and down ladders, twisting of the handle is not necessary and requiring both hands, lessening the need to interrupt painting using both hands to twist the handle (since now the user is enabled in continuing painting with one hand while operating the pressuring pump handle 103′ with the other hand), the container is backpack enabled, lessening the need to interrupt painting to go back to re-roll the longer-handled paint roller of prior non-continuous-feed type paint rolling systems, and the container is enlarged (e.g., up to four gallons of paint), lessening the need to interrupt painting as often to fill a smaller container. Surprisingly, the enhanced continuous roller painting system greatly reduces the time necessary to complete even larger paint jobs. And clean up is easily accomplished whether with water, for latex paints, or spirits traditionally used for cleaning oil-based paints from a traditional paint sprayer device.

The pump handle 103′ prime is preferably pivoted to and at a lower position on the container 102′, and there is a linkage member 168 interconnecting the pump handle and the pressurized cylinder 156. Actuation of the pump handle 103′ therefore activates the linkage member 168 in order to pressurize the cylinder 156 with paint in it, much as a manual reciprocating air pump would be reciprocated to pressurize a bike tire using a cup, cylinder, and valve system housed at 170.

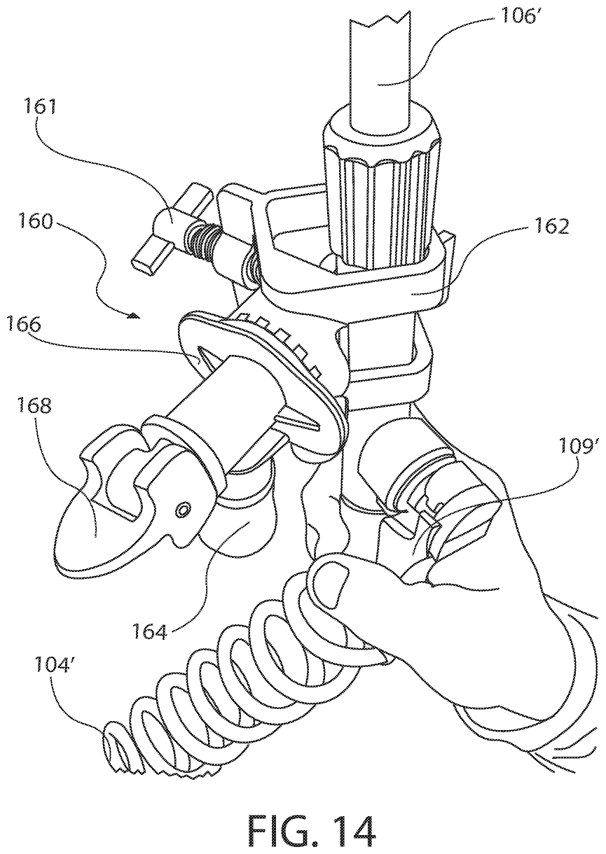

Referring specifically to FIG. 14, there is provided a commercially-available somewhat universal interconnection member 160 for interconnecting the shorter handle 106′ to portion 112′ of pole 142 of this embodiment of the system 100′. The interconnection member 160 thus has a clamp system 162 with a threaded wing-nut type screw 161 adapted for clamping the interconnection member onto the shorter handle 106′, and it has a threaded receptacle 164 adapted for receiving a matching threaded end on portion 112′ of pole 142. The interconnection member 160 further comprises an indexing, rotatably-lockable, pivot member 166 with a thumb-actuated tightening cam 168 adapted for allowing repositioning and locking in position the angle of use of the roller 118 and paint supply frame 116. This is feature particularly allows for enhanced continuous painting of large and sometimes varying angle surfaces with the system of this embodiment 100′.

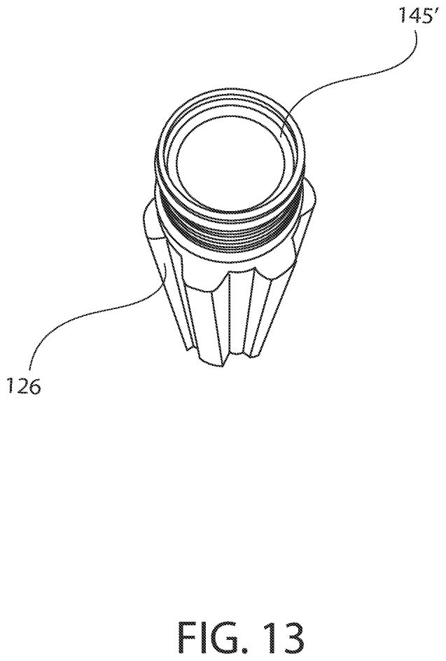

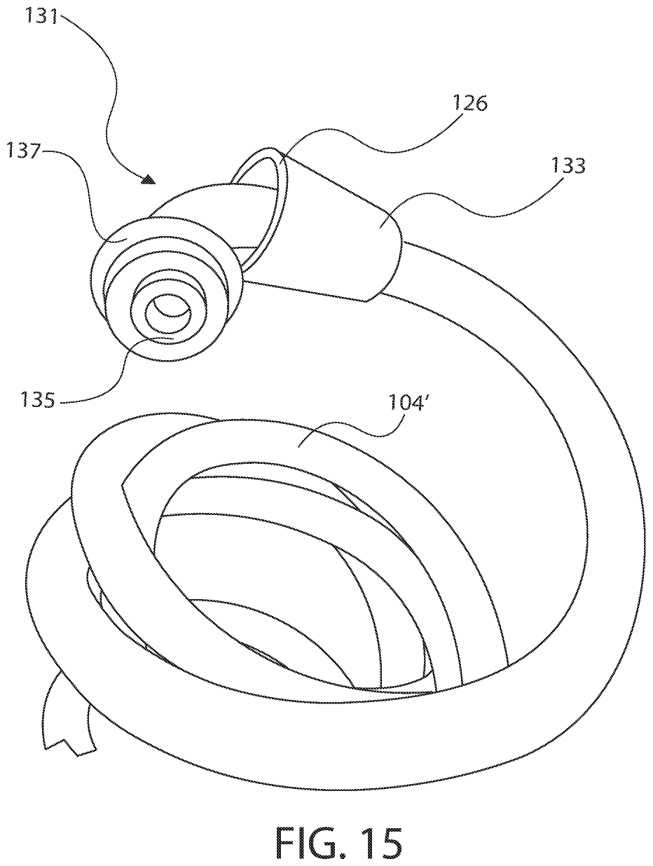

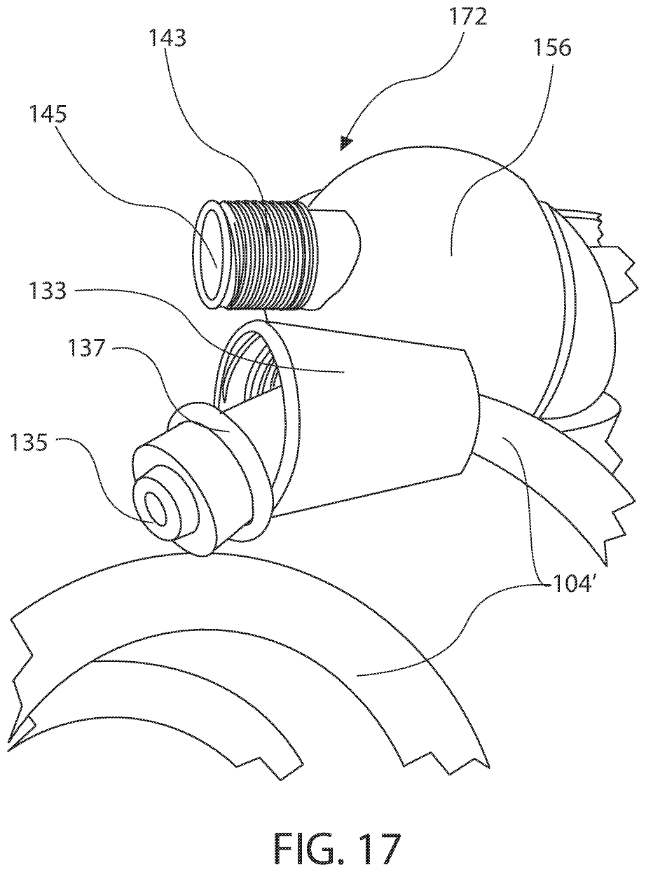

Referring specifically to FIGS. 15 and 17, there is a detailed view of novel interconnections created for the coiled hose 104′ and the commercially available container 102′ with available pressurized cylinder 156 and its outlet port 172. Since the commercially available container 102′ is intended for a different spraying purpose, several of the outlets and inlets of the system are too small to accommodate thicker, more viscous, paint. Further, the type of hose typically used for such available containers 102′ are of a different character and type than that suitable for present purposes as is the coiled, or curly, supply hose 104′. Therefore, the present disclosure comprises an improved interconnection system 131, and method for making the same, for such otherwise available products (container 102′ and coiled hose 104′). The interconnection system 131 comprises a threaded thumb-actuated cap 133, an inner convex-end inner sleeve member 135, and an o-ring 137. Threads 141 of the cap 133 correspond with threads 143 of outlet port 172 of pressurized cylinder 156, for example, to enable screwing of the cap down on the outlet when the convex shape of the inner convex-end insert member 135 is engaged with a mating concave bowl-shaped portion 145 of the outlet port 172. This interconnection system 131 provides a leak-proof seal so that paint cannot escape the interconnection, and this interconnection may be used between the hose 104, 104′ ends and the container 102, 102′, the pressurized cylinder 156, and the handle 106/106′ to hose end connections as well (e.g., see threaded interconnection member 126 of FIG. 13 with concave bowl-shaped adapter 145′ for interconnecting the paint roller frame 116 to either handle 106 or 106′).

To achieve the previously-described seal, a method of creating the interconnection system 131 for adapting previously-existing components (i.e., the coiled hose 104′, the pressurized cylinder outlet port 172, and a pressurized paint rolling system handle 106, 106′) for an enhanced continuous paint roller system 100, 100′ as follows (with heat resistant gloves):
a. Heat the end of the hose 104, 104′ to soften the hose material;
b. Quickly insert the cap 133 over the end of the hose 104, 104′;
c. Quickly insert the o-ring 137 over the end of the hose 104, 104′
d. Insert the convex-end inner sleeve member 135 into the end of the hose 104, 104′; and
e. Allow the hose material to cool, contract and tighten around the convex-end inner sleeve member 135.

In addition to the foregoing modification, to adapt a commercially available sprayer such as that shown, such as a Ryobi® sprayer, or a Greenwood® sprayer, for use as an enhanced continuous pressurized paint rolling system in accordance with one or more aspects and embodiments of the disclosure, the following steps are provided as may be necessary:
a. Make sure all fluid system lines previously designed for less viscous liquid, including ports, and inlets, are adequately sized—for example make sure apertures in the valve at the actuating lever 109, 109′ are bored out to be sufficient to handle paint flow; and
b. Select desired extensible pole 142 with appropriate threaded connections adapted to fit the paint roller frame 116 on the end of handle 106, 106′ with appropriate seated concave/convex seal interconnection systems 131 and collars, caps, or twisting threaded interconnection members, e.g., 126, to appropriately seal areas where paint will be adapted to flow through such components.

While preferred embodiments of the present invention have been shown and described, it will be appreciated that one of ordinary skill in the art will recognize the inventive principles disclosed are not limited to the embodiments disclosed herein, and that various aspects of the invention may be modified without departing from the true spirit of the invention as claimed. Thus, by way of example, it will be appreciated that this invention provides the user with an enhanced-continuous roller painting experience, saving time and money in larger, for example commercial, paint jobs. Further, it will be appreciated that various components of the system, whether container types, handle types, flexible hose types, or other elements, may be mixed and matched without departing from the invention as claimed. The appended claims are therefore intended to cover all such changes and modifications as fall within the true spirit and scope of the invention.

What is claimed is:

1. An improved, higher-capacity, portable, enhanced continuously-fed, paint roller system, comprising:
a portable container adapted for being filled with, and for carrying around a jobsite, more than a gallon of paint;
shoulder straps attached to said portable container;
a porous paint roller having first and second ends, an inner roller structure, and an outer roller material, said roller adapted for allowing paint to absorb into the outer roller material for rolling application to a surface;
a roller conduit frame having perforations therein for allowing paint to pass through the perforations into an interior space defined between said roller and said roller conduit frame, said roller conduit frame defining a channel for feeding paint through the perforations into the interior space for absorption by said roller;
a plurality of sealing cap members adapted for interconnecting and partially sealing the ends of said roller on and around said roller conduit frame;
an elongated handle member interconnected with said roller conduit frame;
a flexible conduit hose leading from said container to, and communicating between, said frame and said container;
means adapted for enhanced continuous pressurization of paint within at least a portion of said container, without requiring loss of dexterity with a longer pole preventing enhanced continuous painting, so that the paint is manually forced through said frame and said frame's perforations into the interior space for absorption by said roller, and adapted to enable enhanced-continuously-fed roller painting by the user; and
a manually actuatable valve adapted for use allowing feeding of paint into said frame.

2. The paint roller system of claim 1, further comprising a reinforced pressure well communicating with said container, and wherein said means adapted for enhanced continuous pressurization of paint comprises a single hand-operable manual lever for pressurizing said pressure well while being adapted for leaving another of a user's hands free to operate said roller via said handle.

3. The paint roller system of claim 1, wherein said means adapted for enhanced continuous pressurization of paint comprises a battery-powered pump for pressurizing at least a portion of said container.

4. The paint roller system of claim 2, further comprising a belt attached to said container and adapted for securing said container around a user's waist.

5. The paint roller system of claim 2, wherein said hand-operable lever is located and extends from a location low on said container, said hand-operable lever extending forward sufficiently far to enable easy compression by the user's hand by pressing in a direction well below shoulder level of the user.

6. The paint roller system of claim 4, wherein said hand-operable lever is located and extends from a location low on said container, said hand-operable lever extending forward sufficiently far to enable easy compression by the user's hand by pressing in a direction well below shoulder level of the user.

7. The paint roller system of claim 4, wherein said container and said hand-operable lever are adapted from a commonly available sprayer container adapted for use with paint by enlarging orifices of the sprayer.

8. The paint roller system of claim 3, wherein said container and said battery-powered pump are adapted from a commonly available sprayer container adapted for use with paint by enlarging orifices of the sprayer.

9. The paint roller system of claim 1, wherein said handle is over a meter long to facilitate enhanced continuous paint rolling in hard-to-reach areas without a ladder.

10. The paint roller system of claim 2, wherein said handle is over a meter long to facilitate enhanced continuous paint rolling in hard-to-reach areas without a ladder.

11. The paint roller system of claim 3, said handle is over a meter long to facilitate enhanced continuous paint rolling in hard-to-reach areas without a ladder.

12. The paint roller system of claim 1, wherein said handle is variably retractable and extensible to over a meter long to facilitate enhanced continuous paint rolling in hard-to-reach areas without a ladder.

13. The paint roller system of claim 2, wherein said handle is variably retractable and extensible to over a meter long to facilitate enhanced continuous paint rolling in hard-to-reach areas without a ladder.

14. The paint roller system of claim 3, wherein said handle is variably retractable and extensible to over a meter long to facilitate enhanced continuous paint rolling in hard-to-reach areas without a ladder.

15. The paint roller system of claim 12, wherein said flexible conduit hose comprises a coiled semi-flexible hose able to extend and retract to accommodate said variously retractable and extensible handle.

16. The paint roller system of claim 13, wherein said flexible conduit hose comprises a coiled semi-flexible hose able to extend and retract to accommodate said variously retractable and extensible handle.

17. The paint roller system of claim 14, wherein said flexible conduit hose comprises a coiled semi-flexible hose able to extend and retract to accommodate said variously retractable and extensible handle.

18. An improved, higher-capacity, portable, enhanced continuously-fed, paint roller system, comprising:
a portable container adapted for being filled with, and for carrying around a jobsite, more than a gallon of paint;
shoulder straps attached to said portable container;
a porous paint roller having first and second ends, an inner roller structure, and an outer roller material, said roller adapted for allowing paint to absorb into the outer roller material for rolling application to a surface;
a roller conduit frame having perforations therein for allowing paint to pass through the perforations into an interior space defined between said roller and said roller conduit frame, said roller conduit frame defining a channel for feeding paint through the perforations into the interior space for absorption by said roller;
a plurality of sealing cap members adapted for interconnecting and partially sealing the ends of said roller on and around said roller conduit frame;
an elongated handle member interconnected with said roller conduit frame;
a semi-flexible conduit hose leading from said container to, and communicating between, said frame and said container;
a manual hand pump adapted for enhanced continuous pressurization of paint within said container so that the paint is manually forced through said frame and said frame's perforations into the interior space for absorption by said roller and further adapted to enable enhanced-continuously-fed roller painting by the user; and
a manually actuatable valve adapted for use allowing feeding of paint into said frame.

19. An improved, higher-capacity, portable, enhanced continuously-fed, paint roller system, comprising:
a portable container adapted for being filled with, and for carrying around a jobsite, more than a gallon of paint;
shoulder straps attached to said portable container;
a porous paint roller having first and second ends, an inner roller structure, and an outer roller material, said roller adapted for allowing paint to absorb into the outer roller material for rolling application to a surface;
a roller conduit frame having perforations therein for allowing paint to pass through the perforations into an interior space defined between said roller and said roller conduit frame, said roller conduit frame defining a channel for feeding paint through the perforations into the interior space for absorption by said roller;
a plurality of sealing cap members adapted for interconnecting and partially sealing the ends of said roller on and around said roller conduit frame;
a hollow elongated handle member having first and second ends and comprising a conduit adapted for fluid communication at the second end of said handle with said frame;
a flexible hose adapted for fluid communication between said container and the first end of said handle;
a battery-powered pump adapted for enhanced continuous pressurization of paint within said container so that the paint is adapted to be forced from said container, through said flexible hose, through said handle, and through said frame and said frame's perforations into the interior space for absorption by said roller to be further adapted to enable enhanced-continuously-fed roller painting by the user; and
a compression-type lever actuatable valve adapted for use allowing feeding of paint into said frame.

20. The paint roller system of claim 19, wherein said handle is variably retractable and extensible to longer than one meter.
